(19) United States
(12) Patent Application Publication
(10) Pub. No.: US 2003/0183721 A1
(43) Pub. Date: Oct. 2, 2003

(54) Freebird

(76) Inventor: Jeffrey J. Wilson, Pittsburgh, PA (US)

Correspondence Address: JAMES RAY & ASSOCIATES, 2640 PITCAIRN ROAD, MONROEVILLE, PA, 15146, US

(21) Appl. No.: 10/390,109

(22) Filed: Mar. 17, 2003

Related U.S. Application Data
(60) Provisional application No. 60/367,560, filed on Mar. 26, 2002.

(51) Int. Cl. B64C 1/00

(52) U.S. Cl. 244/4 A

(57) ABSTRACT

An apparatus for enabling an individual to be propelled through air. The apparatus comprises a framework for holding such individual disposed substantially in a center of the apparatus and a pair of winglike members connected for articulated movement with respect to the framework. There is further a means disposed on the framework for initiating propulsion of the apparatus.

### CROSS-REFERENCE TO RELATED APPLICATIONS

This application is closely related to and claims benefits from U.S. Provisional Application Serials No. 60/367,560 filed Mar. 26, 2002.

### FIELD OF THE INVENTION

The present invention relates in general to an apparatus for permitting a person to glide through the air and, more particularly, the present invention relates to an apparatus for gliding which includes a means for propulsion of said apparatus.

### SUMMARY OF THE INVENTION

The present invention provides an apparatus for enabling an individual to be propelled through air. The apparatus comprises a framework for holding such individual disposed substantially in a center of the apparatus and a pair of winglike members connected for articulated movement with respect to the framework. There is further a means disposed on the framework for initiating propulsion of the apparatus.

The apparatus further includes a plurality of structural members disposed on such winglike members and a covering over such plurality of structural members.

### OBJECTS OF THE INVENTION

It is a primary object of the present invention to provide an apparatus which will permit an operator to glide through the air.

Another object of the present invention is to provide an apparatus which will permit an operator to maneuver the wings in various positions.

Yet another object of the present invention is to provide an apparatus with a means for propulsion attached so as to permit movement when there is little wind.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a front view of the apparatus according to an embodiment of the present invention.

FIG. 2 is a back view of the apparatus of the present invention.

FIG. 3 is a top view of such apparatus of the present invention.

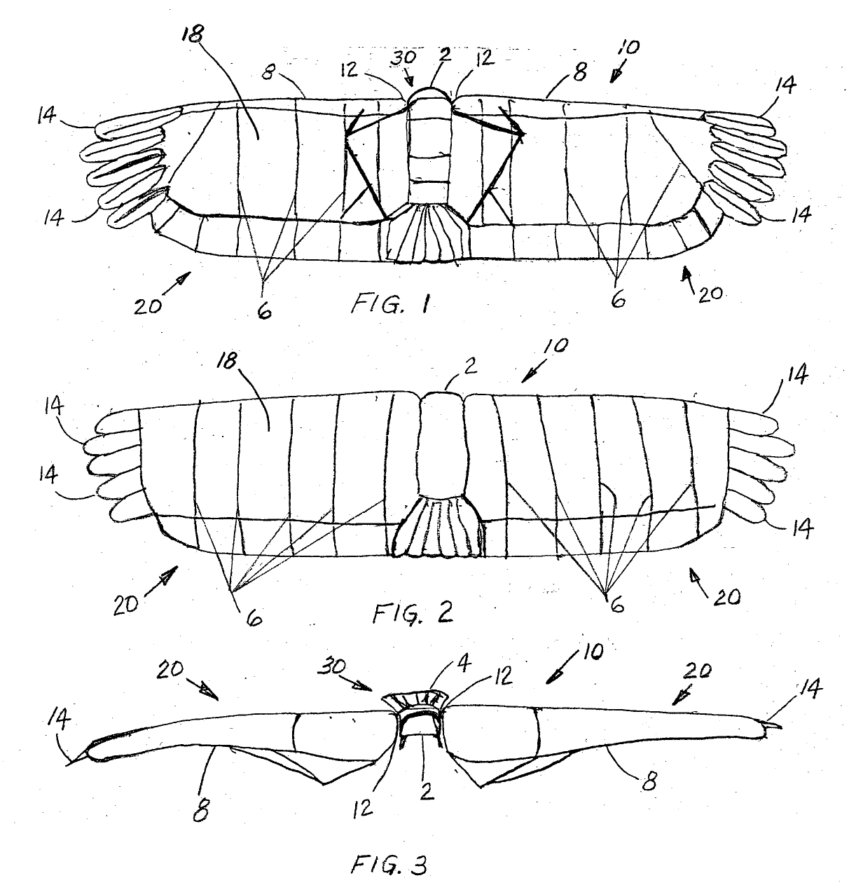

### BRIEF DESCRIPTION OF THE INVENTION

Prior to proceeding with the more detailed description of the present invention it should be noted that, for the sake of clarity, identical components which have identical functions have been designated by identical reference numerals throughout the several views illustrated in the drawings.

The present invention provides an apparatus, generally designated 10, for enabling an individual to be propelled through air. The apparatus 10 has a framework 2 for holding such individual. The framework 2 is disposed substantially in a center of the apparatus 10. The framework 2 is formed from a predetermined material. Such predetermined material is one of plastic and aluminum. The plastic is selected from a group including polyethylene, polypropylene, polyester and polyvinyl chloride. It is also preferred that the plastic is fiber reinforced to provide greater strength. It is presently preferred that such predetermined material is polyethylene or polypropylene.

A pair of winglike members, generally designated 20, are connected for articulated movement with respect to the framework 2. Each of the winglike members 20 are disposed on opposite sides of the framework 2.

The pair of winglike members 20 of such apparatus 10 further include a plurality of structural members 6 and a covering 18 which covers the plurality of structural members 6.

It is presently preferred that such covering 18 is made from plastic sheeting. It is also presently preferred that such plastic sheeting be colored sheeting.

The plurality of structural members 6 includes a main structural member 8 disposed on an upper portion of each of the pair of winglike members 20. The main structural member is connected to the framework 2 by a means, generally designated 30, that is engageable with an end of the main structural member 8 and the framework 2 for both supporting the winglike members 20 and for permitting the winglike members 20 to rotate to various positions. Such means 30 that permits the winglike members 20 to rotate to various positions includes a spherical articulated joint 12. By permitting the winglike members 20 to rotate to various positions provides the user with a better means of steering the apparatus 10 than is possible if the wing like members are fixed in place.

Another feature of the present invention is that the tips of each of the winglike members 20 have the appearance and the shape of feathers 14. It is also presently preferred that these feathers 14 be white.

A means 4 for initiating propulsion of the apparatus is disposed on a rear portion of the framework 2. The means 4 for initiating propulsion is used to assist the apparatus 10 to become airborne when there are insufficient air currents to enable the apparatus 10 to become airborne by just the use of the prevailing air currents. Such means may include a motor, an air tank, a blower and combinations thereof.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. An apparatus for enabling movement of an individual through air, said apparatus comprising:
(a) framework for holding such individual disposed substantially in a center of said apparatus; and
(b) a pair of winglike members connected for articulated movement with respect to said framework.

2. An apparatus, according to claim 1, wherein said pair of winglike members further include a plurality of structural members and a covering over said plurality of structural members.

3. An apparatus, according to claim 2, wherein said plurality of structural members at least includes a main structural member disposed on an upper portion of each of said pair of winglike members.

4. An apparatus, according to claim 3, wherein said main structural member is connected to said framework by a means engageable with an end of said main structural member and said framework for both supporting said winglike members and for permitting said winglike members to rotate to various positions.

5. An apparatus, according to claim 4, wherein said means engageable with said end of said main structural member and said framework for both supporting said winglike members and for permitting said winglike members to rotate to various positions includes a spherical articulated joint.

6. An apparatus for enabling movement of an individual through air, according to claim 1, wherein said apparatus further includes a means disposed on said framework for initiating propulsion of said apparatus.

7. An apparatus, according to claim 2, wherein said plurality of structural members is selected from at least one of aluminum and plastic.

8. An apparatus, according to claim 7, wherein said plastic is selected from a group including polyethylene, polypropylene, polyester and polyvinyl chloride.

9. An apparatus, according to claim 8, wherein said plastic is one of polyethylene and polypropylene.

10. An apparatus, according to claim 1, wherein said covering over said plurality of structural members is plastic.

11. An apparatus, according to claim 1, wherein ends of said winglike members are shaped like feathers.

12. An apparatus for enabling movement of an individual through air, said apparatus comprising:
(a) framework for holding such individual disposed substantially in a center of said apparatus;
(b) a pair of winglike members connected for articulated movement with respect to said framework; and
(c) means disposed on said framework for initiating propulsion of said apparatus.

13. An apparatus, according to claim 12, wherein said pair of winglike members further include a plurality of structural members and a covering over said plurality of structural members.

14. An apparatus, according to claim 13, wherein said plurality of structural members at least includes a main structural member disposed on an upper portion of each of said pair of winglike members.

15. An apparatus, according to claim 14, wherein said main structural member is connected to said framework by a means engageable with an end of said main structural member and said framework for both supporting said winglike members and for permitting said winglike members to rotate to various positions.

16. An apparatus, according to claim 15, wherein said means engageable with said end of said main structural member and said framework for both supporting said winglike members and for permitting said winglike members to rotate to various positions includes a spherical articulated joint.

17. An apparatus, according to claim 13, wherein said plurality of structural members is selected from at least one of aluminum and plastic.

18. An apparatus, according to claim 17, wherein said plastic is selected from a group including polyethylene, polypropylene, polyester and polyvinyl chloride.

19. An apparatus, according to claim 17, wherein said plastic is fiber reinforced.

20. An apparatus, according to claim 12, wherein said covering over said plurality of structural members is plastic.
